(19) United States
(12) Patent Application Publication
(10) Pub. No.: US 2008/0301604 A1
(43) Pub. Date: Dec. 4, 2008

(54) APPARATUS FOR AND METHOD OF ESTIMATING THE QUALITY OF CLOCK GATING SOLUTIONS FOR INTEGRATED CIRCUIT DESIGN

(76) Inventors: Alexander Itskovich, Yokneam llit (IL); Cynthia Rae Eisner, Zichron Yaacov (IL)

Correspondence Address: IBM CORPORATION, T.J. WATSON RESEARCH CENTER, P.O. BOX 218, YORKTOWN HEIGHTS, NY, 10598, US

(21) Appl. No.: 11/755,015

(22) Filed: May 30, 2007

(51) Int. Cl. G06F 17/50

(52) U.S. Cl. 716/6

(57) ABSTRACT

A novel apparatus for and method of estimating the quality of candidate clock gating solutions. The quality estimation mechanism of the present invention filters candidate clock gating solutions by estimating a measure of the quality of each candidate solution. The effect of the proposed solution on both timing and leakage power is considered by determining the intersection coefficient for each candidate clock gating solution. The intersection coefficient (IC) is the number of signals shared by both the data logic portion and clock enable logic portions of a proposed clock gating solution. Only those proposed solutions whose IC value is less than or equal to a threshold are considered as possible clock gating solutions. The IC value functions as a reliable predictor of whether a candidate clock gating solution is a good solution without requiring complex heavy analyses that would normally be applied to the final circuit design.

### REFERENCE TO RELATED APPLICATION

The present invention is related to U.S. application Ser. No. 11/295,936, filed Dec. 7, 2005, entitled “Clock Gating Through Data Independent Logic,” incorporated herein by reference in its entirety.

### FIELD OF THE INVENTION

The present invention relates to the field of integrated circuit design tools and more particularly relates to an apparatus for and method of estimating the quality of clock gating solutions for integrated circuit designs.

### BACKGROUND OF THE INVENTION

Clock gating is a well known technique used to reduce the power consumption of digital hardware circuits. It is often employed as one of several power saving techniques typically applied to synchronous circuits used in large microprocessors and other complex circuits. To save power, clock gating solutions add additional logic to a circuit to modify the functionality of the clock input of a flip-flop or latch, thereby disabling portions of the circuitry where flip-flops or latches do not change state.

Although asynchronous circuits by definition do not employ a ‘clock’ signal, the term ‘perfect clock gating’ is used to show that some clock gating techniques are approximations of the data-dependent behavior exhibited by asynchronous circuitry and that as the granularity of the clock gating employed in a synchronous circuit approaches zero, the power consumption of that circuit approaches that of an asynchronous circuit.

Minimizing switching activity through clock gating is one of the mainstream methods of low-power design. Clock gating can be fine-grained, in which a given clock gating function gates the clock of a small number of flip-flops or latches, or it can be coarse-grained, in which large areas of the integrated circuit chip are turned on and off at the same time. When performed manually, fine-grained clock gating is typically a very labor-intensive process because almost every flip-flop or latch in the design must be considered separately. Furthermore, manual fine-grained clock gating has a low return on investment because the benefits of clock gating a small group of flip-flops or latches are limited. On the other hand, fine-grained clock gating is relatively easy to automate. In addition, there are numerous opportunities, because almost every flip-flop or latch in a design is a candidate for a clock gating solution that minimizes switching activity.

In contrast, coarse-grained clock gating is an architectural-level decision, which is relatively easy to perform manually and can yield a large return on investment for minimal effort. Coarse-grained clock gating, however, is difficult to automate, as it requires some kind of an architectural level understanding of the design. In addition, the number of opportunities for coarse-grained clock gating is relatively small, since there are fewer blocks or units than there are individual flip-flops or latches.

A problem associated with clock gating is that it may create even more severe setup times. This is because putting additional logic on the clock signal requires that logic to arrive sooner in order to ensure that the resultant clock signal arrives before the data.

Another problem is that the additional gates required to implement the clock gating may end up using more in leakage power than is saved in dynamic power through clock gating.

As an example of these problems, consider the example prior art original circuit design shown in FIG. 1A. The circuit, generally referenced 10, comprises a logic cloud 12 and flip-flop 14. The gated design version of the example circuit of FIG. 1A is shown in FIG. 1B. The circuit, generally referenced 20, comprises logic cloud 22, flip-flop 28, xor-gate 24 and and-gate 26.

While the clock gated design of circuit 20 is functionally equivalent to the original ungated design of circuit 10 (FIG. 1A), circuit 20 comprises two more gates than the original circuit 10, which results in an increase in leakage power. Furthermore, the entire cloud of logic driving the data input in the original ungated design 10 now drives the clock gate as well, thus the solution likely violates timing constraints as well. The circuit 20, now has a feedback loop wherein none was present in the original circuit 10, also resulting in increased leakage.

There is thus a need for a hardware development tool mechanism that is able to distinguish and select good clock gating solutions from bad ones, especially in regard to the issues of leakage power and timing. The tool should be able to analyze the fine-grained clock gating opportunities found for a design wherein flip-flops or latches are grouped into gating groups that share the same clock gating function and thus can share a clock buffer. In addition, the mechanism should be capable of estimating the quality of candidate clock gating solutions by filtering out any proposed clock gating solutions that require undue overhead.

### SUMMARY OF THE INVENTION

The present invention is an apparatus for and method of estimating the quality of candidate clock gating solutions. The quality estimation mechanism of the present invention operates on candidate clock gating solutions that are generated using any suitable means. An example of a clock gating technique suitable for use with the present invention is taught in U.S. application Ser. No. 11/295,936, entitled “Clock Gating Through Data Independent Logic,” cited supra. Other known clock gating techniques may also be used without departing from the scope of the invention.

Regardless of the actual technique used, clock gating tools in general are operative to search for clock gating opportunities in a digital circuit design. The result of typical clock gating tools is a plurality of candidate clock gating solutions. A clock gating tool may be standalone, or may be embedded in another tool such as a synthesis or a layout tool. The quality estimation mechanism of the present invention is operative to filter these candidate clock gating solutions. Optionally, the filtered results are reported to a user or simply discarded by the tool. The mechanism is operative to filter the proposed solutions in order to take into account leakage power as well as timing constraints.

The quality estimation mechanism of the invention can optionally be embedded in the clock gating tool itself or accessed as a stand alone application. If embedded the resultant hardware development tool is operative to determine clock gating opportunities in a digital logic design. The tool is able to clock gate any single flip-flop or latch that can be functionally clock gated in addition to grouping flip-flops or latches into gating groups that share the same clock gating function and thus can share a clock buffer. Proposed candidate solutions are filtered using user supplied input parameters thereby eliminating solutions that require undue overhead. This helps to ensure that timing constraints are met and that increased leakage will not eat up the power saved by clock gating.

It is noted that the mechanism of the invention is capable of operating at a relatively early stage in the design cycle. The mechanism operates on clock gating solutions that are generated at a stage in the design wherein the exact logic design is not finalized. The functionality is known but the circuit has not yet been optimized, thus exact timing information or power usage is not available. Thus, the mechanism functions as a reliable predictor of whether a candidate clock gating solution is a good solution or not without requiring complex heavy analyses that would normally be applied to the final circuit design.

Alternatively, the mechanism of the invention could be used at a late stage of the design cycle. In this case, exact timing information and power usage can be calculated, but the invention can be used to filter out obviously bad solutions and thus save processing time.

In operation, a metric called the intersection coefficient is determined for a candidate clock gating solution. The intersection coefficient is defined as the number of signals shared by both the data logic portion and clock enable logic portions of a proposed clock gating solution. It has been determined experimentally that this intersection coefficient can predict the quality of the solution with very high reliability.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of filtering a plurality of candidate clock gating solutions, each candidate clock gating solution incorporating data logic and clock enable logic, the method comprising the steps of for each the clock gating candidate solution, determining a number of input signals shared by the data logic and the clock enable logic of the candidate clock gating solution and considering only clock gating solutions having a number of shared inputs less than or equal to a predetermined threshold.

There is also provided in accordance with the invention, a method of estimating the quality of a plurality of clock gating solutions, the method comprising the steps of determining an intersection coefficient for each candidate clock gating solution, comparing each the intersection coefficient against a predetermined threshold and if the intersection coefficient is less than or equal to the threshold, adding the corresponding candidate clock gating solution to a set of acceptable candidate clock gating solutions.

There is further provided in accordance with the invention, a computer program product comprising a computer usable medium having computer usable program code for estimating the quality of a plurality of candidate clock gating solutions, the computer program product including, computer usable program code for determining an intersection coefficient value of each candidate clock gating solution and computer usable program code for eliminating from consideration candidate clock gating solutions having an intersection coefficient value greater than a predetermined threshold.

### BRIEF DESCRIPTION OF THE DRAWINGS

The invention is herein described, by way of example only, with reference to the accompanying drawings, wherein:

FIG. 1A is an example prior art original circuit design;

FIG. 1B is an example prior art gated design version of the circuit of FIG. 1A;

FIG. 2 is a block diagram illustrating an example computer processing system adapted to implement the quality estimation mechanism of the present invention;

FIG. 3A is an example of an original design before processing by a clock gating tool;

FIG. 3B is an example of an original design after processing by a clock gating tool;

FIG. 3C is an example of a second clock gating solution to the ungated circuit of FIG. 3A;

FIG. 4A is an example feedback loop circuit based on a flip-flop;

FIG. 4B is an example feedback loop circuit based on a latch pair as used in two-phase design;

FIG. 4C is an example feedback loop circuit based on a latch pair with intervening logic as used in two-phase design;

FIG. 5A is a multiplexed example of the application of Theorem 1 of the present invention;

FIG. 5B is a gated example of the application of Theorem 1 of the present invention;

FIG. 6A is a multiplexed example of the application of Theorem 2 of the present invention incorporating a feedback loop;

FIG. 6B is a gated example of the application of Theorem 2 of the present invention incorporating a feedback loop;

FIG. 7A is an example of an original design before processing by a clock gating tool;

FIG. 7B is an example of a gated design after processing by a clock gating tool;

FIG. 8 is a block diagram illustrating an example implementation of the quality estimation mechanism of the present invention;

FIG. 9 is a flow diagram illustrating the intersection coefficient method of the present invention;

FIG. 10A is an example of a VHDL expression as two levels of logic;

FIG. 10B is an example of a VHDL expression as three levels of logic; and

FIG. 11 is a portion of an example Advice file generated by the mechanism of the present invention.

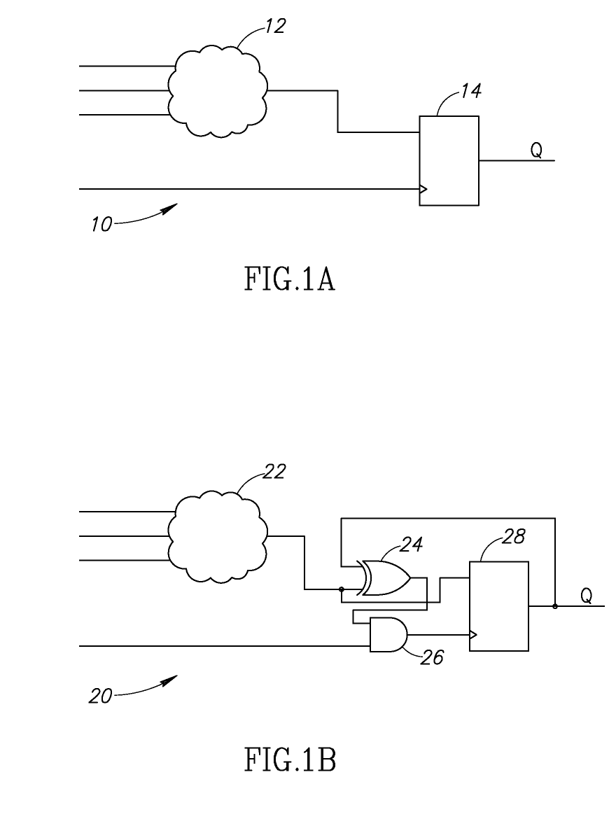

### DETAILED DESCRIPTION OF THE INVENTION

### Notation Used Throughout

The following notation is used throughout this document.

| Term | Definition |
|---|---|
| ASIC | Application Specific Integrated Circuit |
| CD-ROM | Compact Disc Read Only Memory |
| CPU | Central Processing Unit |
| DSP | Digital Signal Processor |
| EEROM | Electrically Erasable Read Only Memory |
| FPGA | Field Programmable Gate Array |
| FTP | File Transfer Protocol |
| HDL | Hardware Description Language |
| HTTP | Hyper-Text Transport Protocol |
| I/O | Input/Output |
| IC | Intersection Coefficient |
| LAN | Local Area Network |
| NIC | Network Interface Card |
| RAM | Random Access Memory |
| ROM | Read Only Memory |
| WAN | Wide Area Network |

### Detailed Description of the Invention

The present invention is an apparatus for and method of estimating the quality of candidate clock gating solutions. The quality estimation mechanism of the present invention operates on candidate clock gating solutions that are generated using any suitable means. An example of a clock gating technique suitable for use with the present invention is taught in U.S. application Ser. No. 11/295,936, entitled “Clock Gating Through Data Independent Logic,” cited supra. Other known clock gating techniques may also be used without departing from the scope of the invention.

Regardless of the actual technique used, clock gating tools in general are operative to search for clock gating opportunities in a digital circuit design. The result of typical clock gating tools is a plurality of candidate clock gating solutions. A clock gating tool may be standalone, or may be embedded in another tool such as a synthesis or a layout tool. The quality estimation mechanism of the present invention is operative to filter these candidate clock gating solutions. Optionally, the filtered results are reported to a user or a simply discarded by the tool. The mechanism is operative to filter the proposed solutions in order to take into account leakage power as well as timing constraints.

The quality estimation mechanism of the invention can optionally be embedded in the clock gating tool itself or accessed as a stand alone application. If embedded the resultant hardware development tool is operative to determine clock gating opportunities in a digital logic design. The tool is able to clock gate any single flip-flop or latch that can be functionally clock gated in addition to grouping flip-flops or latches into gating groups that share the same clock gating function and thus can share a clock buffer. Proposed candidate solutions are filtered using user supplied input parameters thereby eliminating solutions that require undue overhead. This helps to ensure that timing constraints are met and that increased leakage will not eat up the power saved by clock gating.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be borne in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software/firmware embodiment or an embodiment containing both hardware and software/firmware elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

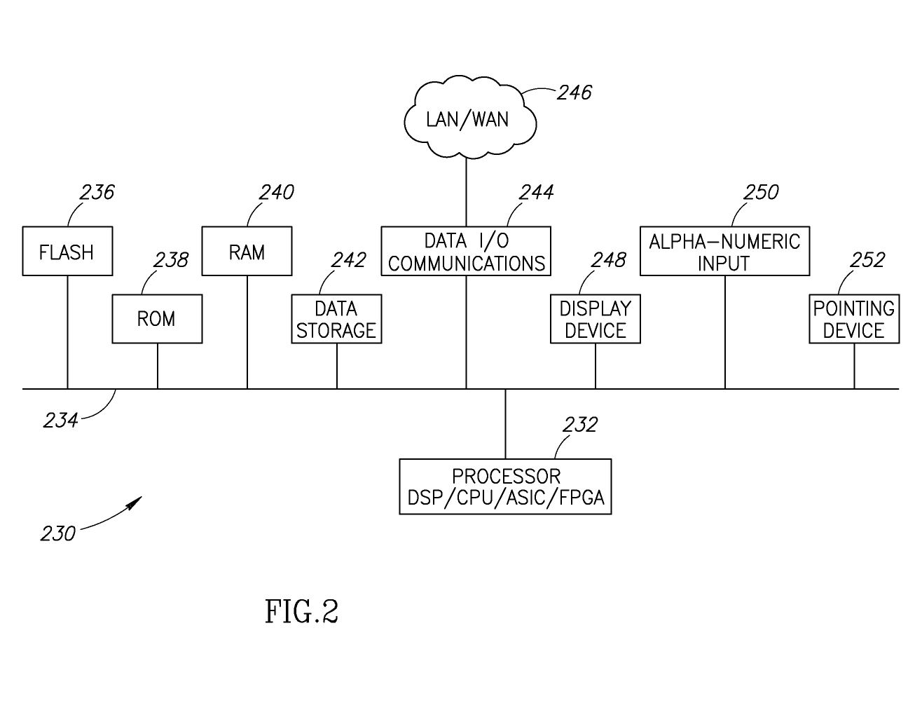

A block diagram illustrating an example computer processing system adapted to implement the quality estimation mechanism of the present invention is shown in FIG. 2. The computer system, generally referenced 230, comprises a processor 232 which may comprise a digital signal processor (DSP), central processing unit (CPU), microcontroller, microprocessor, microcomputer, ASIC or FPGA core. The system also comprises static read only memory 238 and dynamic main memory 240 all in communication with the processor. The processor is also in communication, via bus 234, with a number of peripheral devices that are also included in the computer system. Peripheral devices coupled to the bus include a display device 248 (e.g., monitor), alpha-numeric input device 250 (e.g., keyboard) and pointing device 252 (e.g., mouse, tablet, etc.)

The computer system is connected to one or more external networks such as a LAN or WAN 246 via communication lines connected to the system via data I/O communications interface 244 (e.g., network interface card or NIC). The network adapters 244 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 242 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the quality estimation mechanism is adapted to reside on a computer readable medium, such as a magnetic disk within a disk drive unit. Alternatively, the computer readable medium may comprise a floppy disk, removable hard disk, Flash memory 236, EEROM based memory, bubble memory storage, ROM storage, distribution media, intermediate storage media, execution memory of a computer, and any other medium or device capable of storing for later reading by a computer a computer program implementing the method of this invention. The software adapted to implement the quality estimation mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the quality estimation mechanism of the present invention, and to the extent that a particular system configuration is capable of implementing the system and methods of this invention, it is equivalent to the representative digital computer system of FIG. 2 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

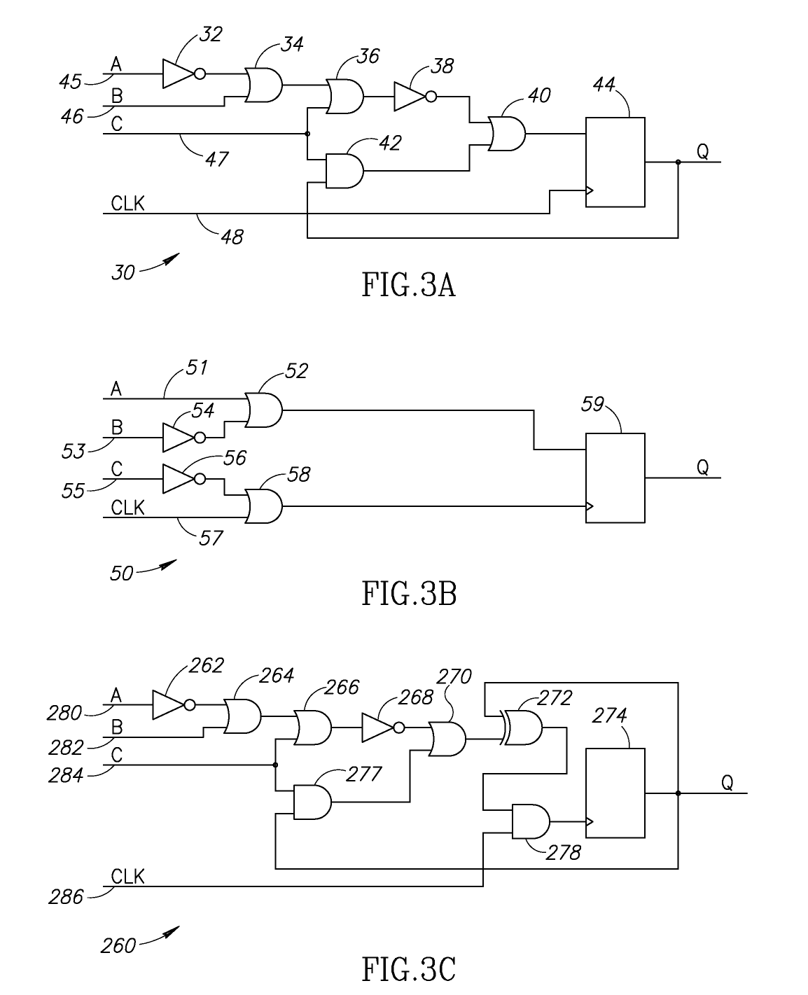

As stated supra, the quality estimation mechanism of the invention is operative to filter the candidate clock gating solutions generated by a clock gating tool. An example of a good clock gating solution that might be proposed by a prior art tool is described herein. An example of an original design before processing by a clock gating tool is shown in FIG. 3A. The circuit, generally referenced 30, comprises not-gates 32, 38, or-gates 34, 36, 40, and-gate 42 and flip-flop 44. The circuit comprises three input signals A 45, B 46, C 47 and a clock signal CLK 48.

The circuit after processing by a clock gating tool is shown in FIG. 3B. The circuit, generally referenced 50, comprises not-gates 54, 56, and-gates 52, 58 and flip-flop 59. The circuit now comprises a data portion with input signals A 51, B 53 and a clock enable portion with input signals C 55 and CLK 57. The clock-gated circuit design 50 is functionally equivalent to the original ungated circuit design 30. The clock-gated circuit design, however, uses fewer logic gates than the original circuit 30, thus reducing the leakage power as well as switching power. Furthermore, the amount of logic driving the clock gate is relatively small and has a good chance of meeting any required timing constraints.

It is noted that for simplicity's sake, throughout this document, clock gating is represented graphically in the figures by showing an and-gate driving the clock input of a flip-flop. It is appreciated, however, that the mechanism is operative to recognize and process clock gating performed by other means, for instance using specialized clock buffers or other modifications to the clock tree. Furthermore, it is noted that while throughout this document clock gating is shown to be applied to flip-flops, it is appreciated that the mechanism is operative to recognize and process latches, latch pairs such as seen in two-phase design styles, including latch pairs with intervening logic, and any other memory element that may be clock gated.

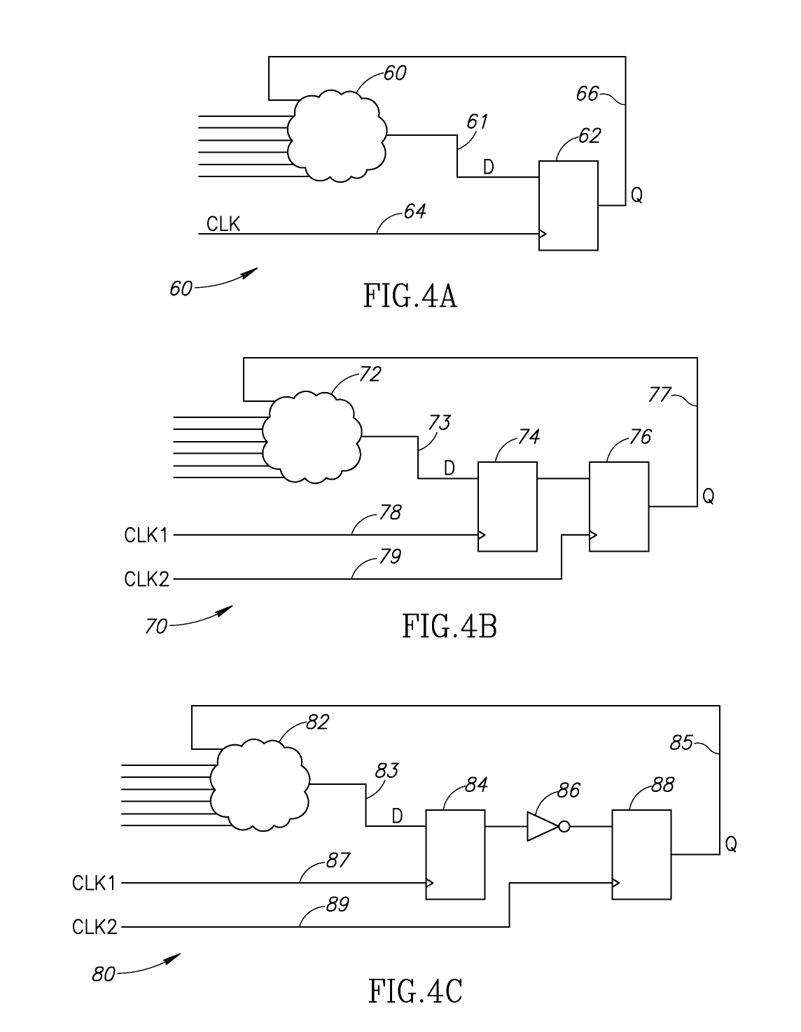

The clock gating tool of U.S. application Ser. No. 11/295,936, cited supra, for example, is operative to search the digital circuit for opportunities to eliminate feedback loops. A feedback loop includes, inter alia, the case where the data output of a flip-flop or L1-L2 latch pair feeds into the data input of the same flip-flop or L1-L2 latch pair. Three examples of feedback loops are shown in FIGS. 4A, 4B and 4C, wherein FIG. 4A shows an example feedback loop circuit based on a flip-flop, FIG. 4B shows an example feedback loop circuit based on an L1-L2 pair and FIG. 4C shows an example feedback loop circuit based on an L1-L2 pair with intervening logic.

The clock gating method depends on Theorems 1 and 2 below. We use x₀, x₁, . . . to denote variables and a₀, a₁, . . . to denote constants. The theorems and their proof depend on the fact that if we have a function f(x₀, x₁, . . . , xₙ, q), and we set the values of the variables xᵢ, the result is a function f′(q). Note that there are only four such functions, including: f₀(q)≡0; f₁(q)≡1; f₂(q)≡q; and f₃(q)≡ [symbol] q.

Theorem 1: Let f(x₀, x₁, . . . , xₙ, q) be a function. Then there exist functions g(x₀, x₁, . . . , xₙ) and h(x₀, x₁, . . . , xₙ) such that

$$f ( {x}_{0} , {x}_{1} , … , {x}_{n} , q ) ≡ \{ \begin{matrix}h ( {x}_{0} , {x}_{1} , … , {x}_{n} ) & if g ( {x}_{0} , {x}_{1} , … , {x}_{n} ) = 1 \\ q & otherwise\end{matrix} \\ iff ∄ {a}_{0} , {a}_{1} , … , {a}_{n} such that f ( {a}_{0} , {a}_{1} , … , {a}_{n} , q ) ≡ q . \qquad ( 1 )$$

Theorem 2: Let f(x₀, x₁, . . . , xₙ, q) be a function. Then there exist functions g₁(x₀, x₁, . . . , xₙ), g₂(x₀, x₁, . . . , xₙ) and h(x₀, x₁, . . . , xₙ) such that

$$f ( {x}_{0} , {x}_{1} , … , {x}_{n} , q ) ≡ \{ \begin{matrix}h ( {x}_{0} , {x}_{1} , … , {x}_{n} ) & if {g}_{1} ( {x}_{0} , {x}_{1} , … , {x}_{n} ) = 1 \\ q & if {g}_{2} ( {x}_{0} , {x}_{1} , … , {x}_{n} ) = 1 \\ q & otherwise\end{matrix} \qquad ( 2 )$$

The functions g and g₁ can be constructed by building the function f|_{q=0}=f|_{q=1}. The function g2 can be constructed by building the function

$${g}_{2} ( {a}_{0} , {a}_{1} , … , {a}_{n} ) = \{ \begin{matrix}1 & if f ( {a}_{0} , {a}_{1} , … , {a}_{n} , q ) ≡ {f}_{3} ( q ) \\ 0 & otherwise\end{matrix}$$

The function h can be constructed by building (f if g else undefined). The condition [symbol] a₀, a₁, . . . , aₙ such that f(a₀, a₁, . . . , aₙ, q)≡ [symbol] q can be tested by comparing the function

$$p ( {x}_{0} , {x}_{1} , … , {x}_{n} , q ) ≡ \{ \begin{matrix}q & if g ( {x}_{0} , {x}_{1} , … , {x}_{n} ) = 1 \\ f ( {x}_{0} , {x}_{1} , … , {x}_{n} , q ) & otherwise\end{matrix} \qquad ( 2 )$$

to the function f₂(q)=q. This provides a practical method to perform clock gating automatically.

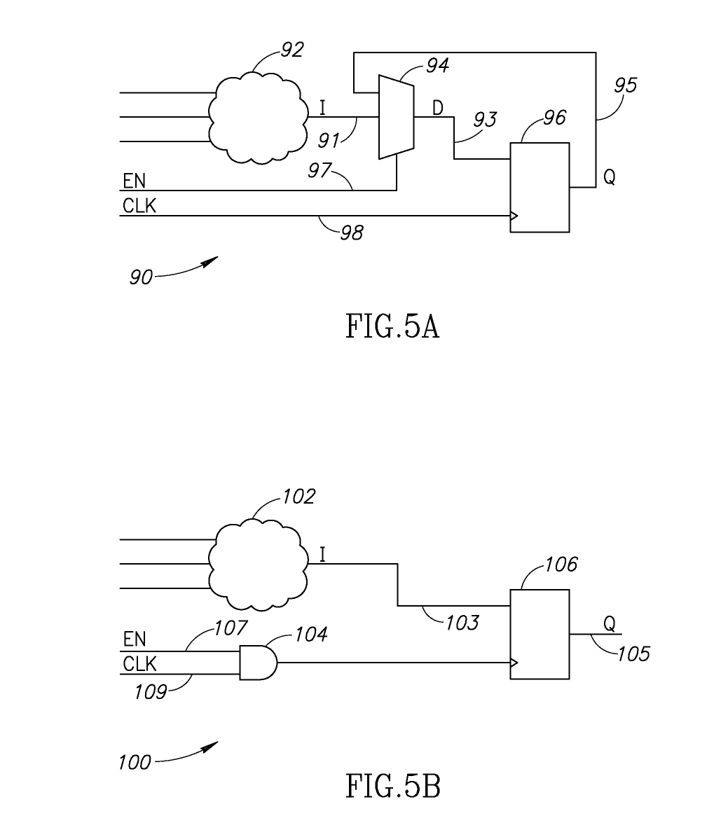

An example of Theorem 1 is illustrated in FIGS. 5A and 5B. Note that the method of the invention is capable of handling both trivial and non-trivial cases, for instance, the non-trivial case shown in FIG. 3A. A multiplexed example of the application of Theorem 1 of the present invention is shown in FIG. 5A. The circuit, generally referenced 90, comprises a logic cloud 92 with output signal I 91, multiplexer 94 with control EN signal 97, flip-flop 96 with D input 93, Q output 95 and clock input 98.

A gated example of the application of Theorem 1 of the present invention is shown in FIG. 5B. The circuit, generally referenced 100, comprises logic cloud 102 with output signal I 103, and-gate 104 with EN input 107 and clock input CLK 109, and flip-flop 106 with Q 105 output. In this clock gating solution, the multiplexer 94 was eliminated and the CLK signal gated by and-gate 104. In operation, when the enable EN is asserted the Q gets a new value I. If EN is not asserted, then Q retains its value.

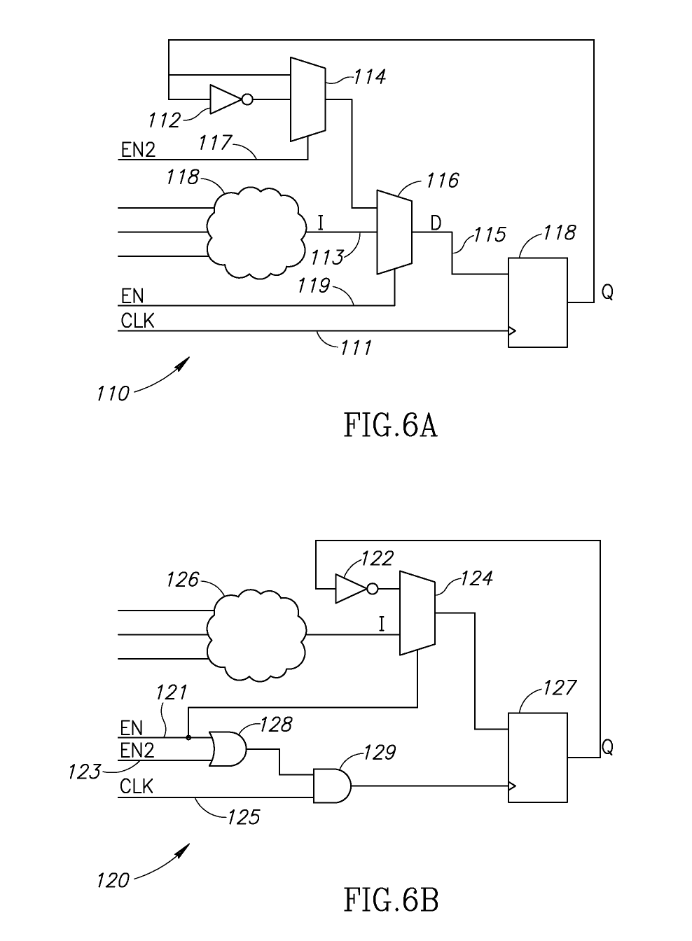

If ∃a₀, a₁, . . . aₙ such that f (a₀, a₁, . . . , aₙ, q)≡ [symbol] q, then clock gating can be performed. The feedback loop, however, cannot be eliminated. An example of this is shown in FIGS. 6A and 6B. A multiplexed example of the application of Theorem 2 of the present invention incorporating a feedback loop is shown in FIG. 6A. The circuit, generally referenced 110, comprises not-gate 112, multiplexer 114 with control input EN2 117, logic cloud 118 with output signal I 113, multiplexer 116 with control input EN 119 and output signal D 115 input to the data input of flip-flop 118. The clock signal CLK 111 provides timing for flip-flop 118.

A gated example of the application of Theorem 2 of the present invention incorporating a feedback loop is shown in FIG. 6B. The clock gated circuit, generally referenced 120, comprises logic cloud 126 with output signal I, multiplexer 124 with control input EN 121 and input comprising the output of not-gate 122 and signal I, or-gate 128 with enable inputs EN 121 and EN2 123, and-gate 129 with CLK input 125 and flip-flop 127.

### Filtering the Theoretical Solutions for Practicality

The clock gating method described supra is able to eliminate the feedback loop in 100% of the cases in which it is theoretically possible to do so. Furthermore, it simplifies the logic in all other cases in which a feedback loop is present and there exists at least one assignment of the variables x₀ through xₙ such that f (a₀, a₁, . . . , aₙ, q)≡q. Not every theoretical solution arrived at by a clock gating tool is useful in practice. A solution that adds too much logic might end up wasting more in leakage power than it saves by clock gating. In addition, many theoretical solutions will not obey timing constraints. And finally, a gating function not applicable to a large enough number of flip-flops or latches will waste expensive clock buffers.

The problem of wasting clock buffers can be solved by allowing the user to specify the size of the minimum Gating Group, referred to as the S4G (size for group) parameter. Only gating functions that can be used to gate at least the specified number of flip-flops or latches are allowed, the rest are discarded.

The issues of leakage power and timing, however, are more complex.

One approach is to perform power simulations and static timing analyses within the development tool. Doing so, however, would add a great deal of complication to the tool and would greatly increase run times. Furthermore, the exact timing and power usage depends on the technology mapping and optimizations to be performed by synthesis and/or, thus sometimes only an estimate is possible.

Instead, the mechanism of the present invention utilizes a heuristic approach. To control leakage power, the mechanism uses heuristics to limit the solutions to those that require less logic gates to implement than the original, ungated design. In this manner, it is guaranteed that the mechanism of the invention does not waste more in leakage than it gains through clock gating.

This is achieved by using what is called the Intersection Coefficient (IC) which is defined as the number of input signals shared by the data logic and clock enable logic portions of a proposed clock gating solution. It has been determined experimentally that the intersection coefficient can predict the quality of the solution with very high reliability. For example, in FIG. 3B, the IC value is zero (IC=0) since the data and the clock enable logic are completely disjoint.

Stated mathematically, assume that for some flip-flop F there exists both a new function d′ for the data input to the flip-flop and a gate function en for the flip-flop. Let S_{d′} be a set of signals affecting d′ and let Sₑₙ be a set of signals affecting en. Thus, if S equals the intersection of S_{d′} and Sₑₙ, then the intersection coefficient (IC) is the size of the set S. Note that IC is a positive natural number or zero in the case S is the empty set.

Note that for a particular circuit, there may be multiple clock gating solutions. The IC is a function of the particular clock gating solution, rather than a function of the circuit. For instance, consider the circuit of FIG. 3C. The circuit, generally referenced 260, comprises not-gates 262, 268, or-gates 264, 266, 270, and-gates 277, 278, xor-gate 272, flip-flop 274. The circuit also comprises three input signals A 280, B 282, C 284 and clock signal CLK 286. The circuit 260 is a second clock gating solution to the ungated circuit 3A, and thus is functionally equivalent to FIG. 3B.

Using a specified limit on the IC, referred to as IC_LIMIT, it is possible to divide a set of candidate clock gating logical solutions into two groups in accordance with the value of each solution's IC: (1) a satisfactory or acceptable group wherein IC<=IC_LIMIT and an unsatisfactory or unacceptable group wherein IC>IC_LIMIT. The unacceptable group comprises candidate logical solutions which are not like to satisfy timing and/or power usage requirements. A key benefit of the mechanism of the invention is that it enables very fast estimation of the quality of candidate clock gating solutions without using time-expensive synthesis tools, static timing analysis tools, layout tools or power estimation tools.

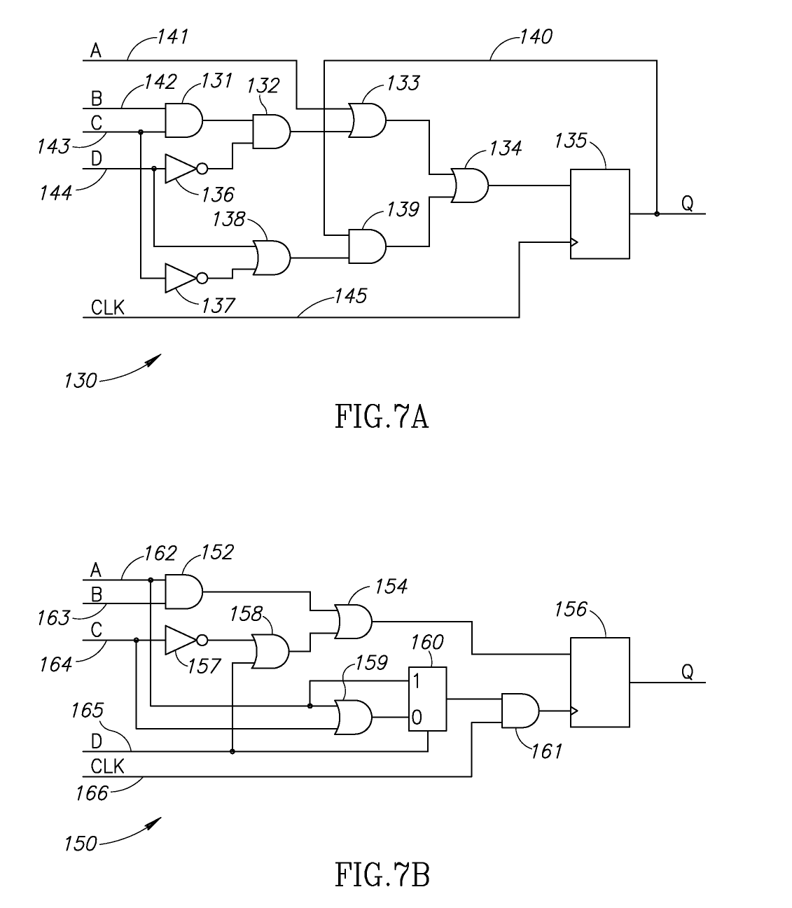

Another example of an original design before clock gating is shown FIG. 7A. The circuit, generally referenced 130, comprises flip-flop 135 having Q 140 output and CLK input 145, and-gates 131, 132, 139, or-gates 133, 134, 138, not-gates 136, 137 coupled to signals A 141, B142, C 143 and D 144.

An example of the design after application of a clock gating tool is shown in FIG. 7B. The circuit, generally referenced 150, comprises flip-flop 156 having Q output, and-gate 161 with CLK input 166, multiplexer 160 having control input D 165, or-gates 152, 154, 158, 159, not-gate 157, coupled to signals A 162, B163, C 164 and D 165. The intersection coefficient value for circuit 150 equals three (IC=3) because signals A, C and D all participate in both the data logic as well as the clock enable logic portions of the circuit.

In operation, an IC parameter is supplied by the user and the mechanism uses this parameter as a threshold against which the measured IC value of each candidate solution is compared to. A solution is considered acceptable only if its IC value is less than or equal to the threshold. The inventors have found experimentally that the value of the IC parameter allows good control over the quality of the result, both with respect to timing as well as with respect to reducing the number of gates (and thus leakage power).

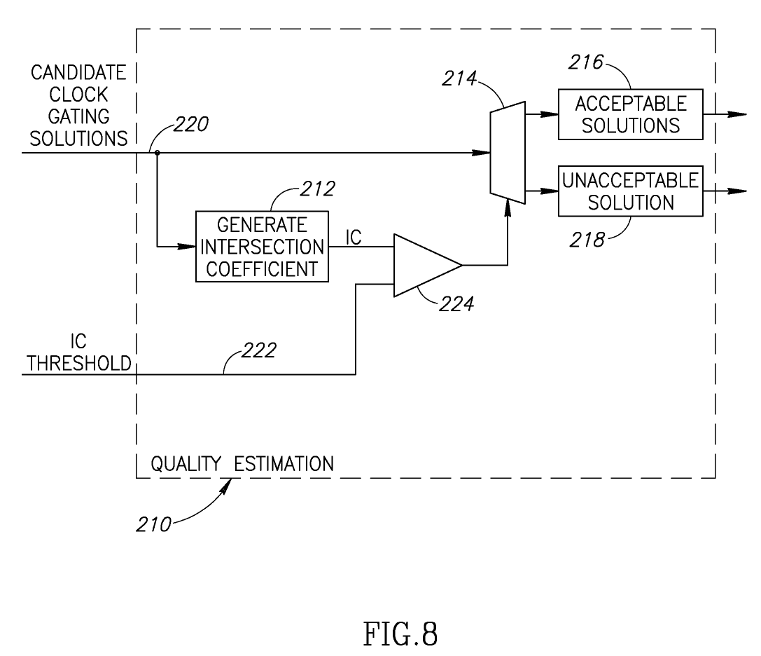

A block diagram illustrating an example implementation of the quality estimation mechanism of the present invention is shown in FIG. 8. The quality estimation circuit, generally referenced 210, comprises an intersection coefficient generator 212 adapted to receive candidate clock gating solutions 220, comparator 224 adapted to compare each solution to an IC threshold 222, 1 to 2 demultiplexer 214 adapted to place each solution in either an acceptable list 216 or unacceptable list 218 in accordance with the results of the comparison.

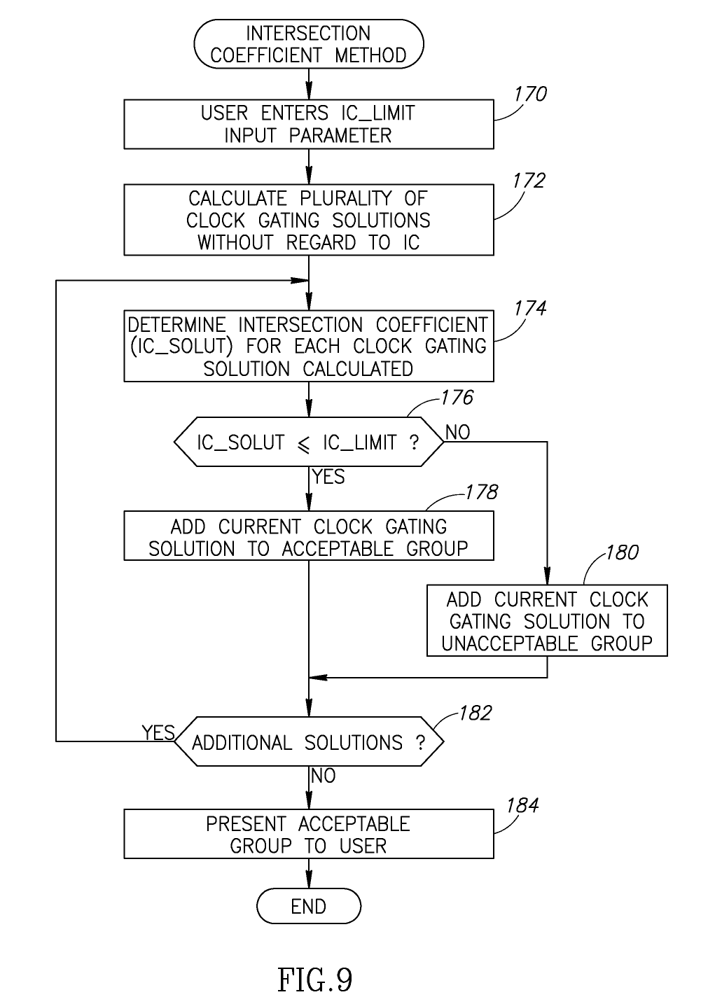

A flow diagram illustrating the intersection coefficient method of the present invention is shown in FIG. 9. In the example embodiment of the invention presented herein, the user provides an IC_LIMIT input parameter to the quality estimation mechanism that is used to threshold each candidate solution (step 170). A plurality of clock gating solutions are generated (step 172). The intersection coefficient (IC) IC_SOLUT for each candidate clock gating solution is determined (step 174). If the IC_SOLUT is less than or equal to the IC_LIMIT (step 176), then the candidate solution is added to an acceptable group of solutions (step 178), otherwise, it is added to an unacceptable group (step 180). Alternatively, unacceptable solutions can be discarded. If there are additional solutions (step 182), the method returns to step 174, otherwise the acceptable group is presented to the user (step 184).

Note that the mechanism can be adapted to either generate each candidate solution and perform the IC comparison sequentially or to generate all the candidate solutions and then sequentially filter each against the threshold.

Note that a candidate solution with IC=0 is a good (and very likely the best) solution because the signals effecting the flip-flop data input and the gated clock signal are separated. Thus, the size of the design has likely been reduced by several logical gates.

For an IC of 1, experiments conducted by the inventors have shown that the size of the design usually does not increase. If the IC value is greater than 1, the estimation of quality of changes in logic depends on the particular features of the design. Nevertheless, the restriction of maximal admissible value of IC noticeably facilitates the filtering of unacceptable changes in logic.

Table 1 below shows the effect of various values of IC on a single design comprising 1126 flip-flops, 338 of which can be potentially gated. Critical slack of the original design is 4.5 for a clock period of 40 ns and comprised of 2689 logical gates. The table demonstrates the effect of the restriction of maximal admissible value of IC on the quality of the solution. The table was generated using a design that allows tracking the dynamics of deterioration of the solution with the increase of IC limit. Moreover, there is a “red line” beyond which the solution becomes unsatisfactory. As the value of IC grows, the percentage of the flip-flops or latches in the design that can be gated grows as well. At high values of IC, however, timing is negatively impacted and there is an increase rather than a decrease in the number of gates. Note that negative impact is indicated by negative improvement in columns 3 and 4 of Table 1. The pattern shown in Table 1 is consistent across many designs that have been experimented, and based on these results, the IC threshold parameter is by default set to IC=1. Note that negative numbers for critical slack and number of gates represents a worse result than the original while positive numbers represent an improvement.

TABLE 1
Influence of IC value on timing and number of gates

| | Flip-Flop | | | | | | |
|---|---|---|---|---|---|---|---|
| | # Gated | | | Critical Slack | | Gates | |
| | | Q and | | | Im- | | Im- |
| | Q | Q! | % Gated | | provement | | provement |
| IC | only G | gn | (g + gn)/n | New | % | New | % |
| 0 | 76 | 0 | 6.75% | 5.56 | 23.60% | 2655 | 1.26% |
| 1 | 156 | 0 | 13.85% | 5.57 | 23.90% | 2547 | 5.28% |
| 2 | 160 | 0 | 14.21% | 5.42 | 20.63% | 2645 | 1.64% |
| 10 | 164 | 0 | 14.56% | 5.41 | 20.28% | 2701 | −0.45% |
| 11 | 164 | 2 | 14.74% | 5.55 | 23.32% | 2717 | −1.04% |
| 12 | 224 | 7 | 20.52% | 3.76 | −16.38% | 3404 | −26.59% |
| 13 | 226 | 7 | 20.69% | 3.48 | −22.57% | 3447 | −28.19% |
| 15 | 236 | 7 | 21.58% | 3.10 | −31.17% | 3616 | −34.47% |
| 19 | 236 | 9 | 21.76% | 2.84 | −36.90% | 3692 | −37.30% |
| 21 | 237 | 9 | 21.85% | 2.84 | −36.90% | 3713 | −38.08% |
| 23 | 239 | 9 | 22.02% | 2.72 | −39.62% | 3769 | −40.16% |

The data presented in Table 1 illustrates that controlling the value of the IC threshold allows synthesis process characteristic such as critical slack and the number of gates to be regulated. If it is desired not to worsen the critical slack, a value of IC=11 is the best choice, while if it is desired not to increase the number of gates, the best result can be achieved by setting this limit at IC=2.

Depending on the implementation of the invention, the IC_LIMIT parameter may be configured as an input parameter by the user, fixed by the software/firmware/hardware mechanism or configured dynamically in accordance with one or more metrics measured during processing of the candidate solutions.

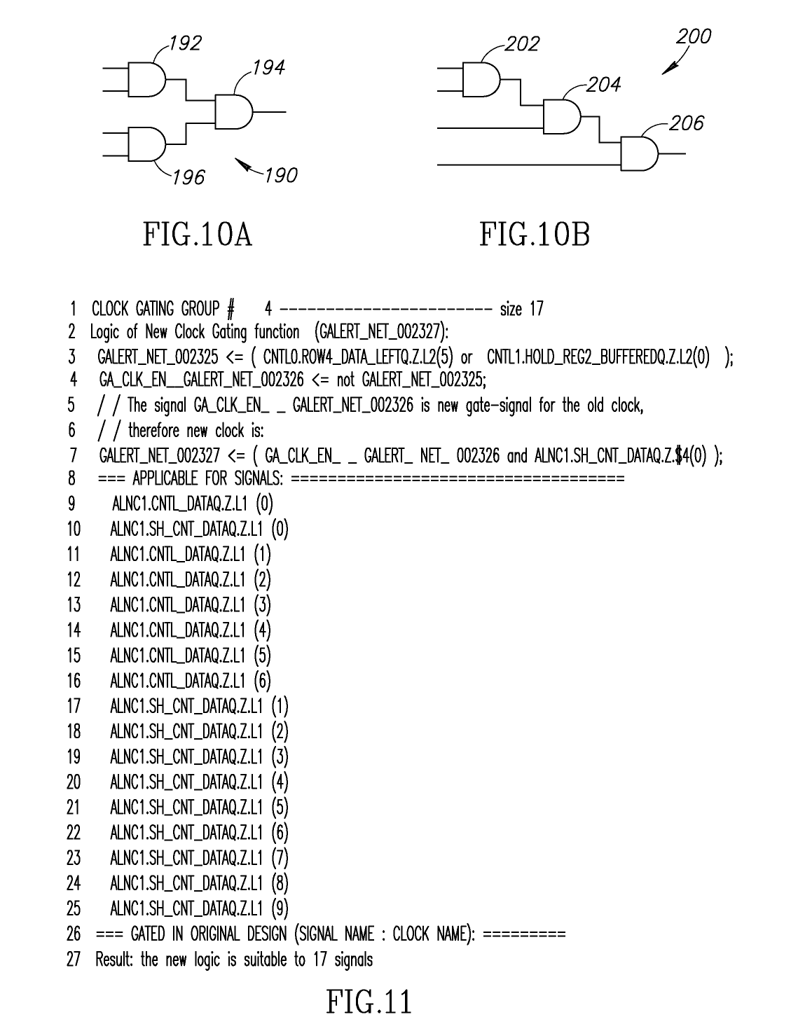

As shown above, the IC value provides some control over the timing as well as the size of the generated logic. In addition, additional heuristics are used that enable to limit the amount of logic on the clock enable. The DPT parameter is a rough measure of the depth of the logic when implemented with two-input and-gates and or-gates. For example, the VHDL expression a and b and c and d can be implemented with two levels of logic as in FIG. 10A or somewhat inefficiently with three levels as in FIG. 10B. The development tool of the invention is not operative to optimize the logic (this is left for the synthesis tool), thus it interprets the function a and b and c and d as either two or three levels of logic, depending on the internal representation. Thus, it is preferable to run the development tool using a DPT parameter that is higher than the actual depth that we are willing to see on the clock gating logic. By experimentation, it has been found that DPT=12 yields acceptable results.

As opposed to leakage power, which can be controlled completely through the IC parameter, neither the IC nor the DPT parameter guarantees that timing constraints can be met. They do, however, enable the filtering out of those which are clearly problematical. The designer would then use her/his judgment in implementing the remaining advice provided by the development tool of the invention while always having the option to cancel the clock gating later in the design cycle if timing constraints cannot be met.

As an illustration of an example embodiment of the development tool of the invention, a representative portion of an actual advice file, output of the development tool, is provided in FIG. 11. The output has been annotated with line numbers for easy reference. Line 1 indicates that the results that follow are for gating group #4, containing 17 L1-L2 latch pairs. Line 2 indicates that the new clock is called GALERT NET 002327. Lines 3-7 give the functionality of the new clock.

It is noted that for simplicity the advice is provided as if an and-gate is to be used to gate the clock. Depending on circumstances, the designer may use a clock buffer instead. Thus, signal GALERT NET 002327 is the ‘and’ of the gating function given by GA CLK EN GALERT NET 002326 and the original clock given by ALNC1.SH CNT DATAQ.Z.$4(0). In practice, the designer using the results provided in the advice file takes the clock gating function from Line 5.

Lines 9 through 25 show that L1 latches of the L1-L2 latch pairs for which this gating function is applicable. The 17 L1-L2 latch pairs shown are composed of two sets of related signals: ten bits of ALNC1.SH CNT DATAQ and seven bits of ALNC1.SH CNT DATAQ.

As a further example, the mechanism was applied to several different circuits, the results of which are presented below in Table 2. The values of the intersection coefficient (IC), gating group (S4G) and depth (DPT) parameters are shown in columns 2 through 4. Column 5 shows the number of L1-L2 pairs in the block and columns 6-7 show the number and percentage of those pairs that were candidates for clock gating. A clock gating candidate is an L1-L2 pair that can be clock gated according to the method described supra. Columns 8-9 show the number and percentage of the total L1-L2 pairs were solved (i.e. remained after filtering by the IC, S4G and DPT parameters).

TABLE 2
Gating and filtering results for various circuits

| | | | | | Candi- | | | |
|---|---|---|---|---|---|---|---|---|
| | | | | # L1–L2 | dates | | Solved | |
| Name | IC | S4G | DPT | pairs | # | % | # | % |
| L15_ARB_WRAP | 1 | 6 | 12 | 4076 | 358 | 8.78 | 37 | 0.91 |
| NC_KTOP | 1 | 6 | 12 | 9535 | 430 | 4.51 | 106 | 1.11 |
| MCA_CMDQ_WRAP | 1 | 6 | 12 | 27849 | 2353 | 8.45 | 335 | 1.20 |
| L_PINTR | 1 | 12 | 12 | 5920 | 232 | 3.92 | 72 | 1.22 |
| HT_KTOP | 1 | 6 | 12 | 54638 | 3539 | 6.48 | 681 | 1.25 |
| L2_RD_WRAP | 1 | 6 | 12 | 10121 | 1372 | 13.56 | 190 | 1.88 |
| F_BFU_KTOP | 5 | 10 | 0 | 12103 | 685 | 5.66 | 239 | 1.97 |
| PB_CMD_SNOOPER_KMAC | 1 | 6 | 12 | 475 | 24 | 5.05 | 10 | 2.11 |
| C_TSENSOR_CPM_TOP | 6 | 8 | 12 | 359 | 39 | 10.86 | 8 | 2.23 |
| IFBC_IFAR_CTL_KMAC | 1 | 12 | 12 | 2282 | 141 | 6.18 | 52 | 2.28 |
| L15_SN_WRAP | 1 | 6 | 12 | 5074 | 429 | 8.45 | 124 | 2.44 |
| CA_RF_VRF_KMAC | 1 | 6 | 12 | 775 | 21 | 2.71 | 21 | 2.71 |
| PC_TR_SPR_KMAC | 6 | 8 | 12 | 1259 | 197 | 15.65 | 36 | 2.86 |
| L2_LRC_WRAP | 1 | 6 | 12 | 2551 | 156 | 6.12 | 75 | 2.94 |
| MCNWSC_KMAC | 1 | 6 | 12 | 612 | 83 | 13.56 | 18 | 2.94 |
| MCGSSCM_KMAC | 1 | 6 | 12 | 1167 | 209 | 17.91 | 35 | 3.00 |
| L15_MISC_WRAP | 1 | 6 | 12 | 3059 | 285 | 9.32 | 109 | 3.56 |
| MCNWQ_KMAC | 1 | 6 | 12 | 186 | 42 | 22.58 | 7 | 3.76 |
| L2_MISC_WRAP | 1 | 6 | 12 | 4240 | 460 | 10.85 | 173 | 4.08 |
| PC_TRR_SPR_REGS_KMAC | 6 | 8 | 12 | 1204 | 209 | 17.36 | 50 | 4.15 |
| PC_TIMEFAC_KWRAP | 6 | 8 | 12 | 4357 | 845 | 19.39 | 192 | 4.41 |
| TP_AD_KTOP | 1 | 6 | 12 | 7035 | 1353 | 19.23 | 365 | 5.19 |
| TP_CFAM_KTOP | 1 | 6 | 12 | 10788 | 2520 | 23.36 | 583 | 5.40 |
| L2QD_KTOP | 1 | 6 | 12 | 41528 | 2707 | 6.52 | 2468 | 5.94 |
| MC_GLOBA_WRAP | 1 | 6 | 12 | 5605 | 996 | 17.77 | 382 | 6.82 |
| TP_FIR_KMAC | 1 | 6 | 12 | 1331 | 248 | 18.63 | 91 | 6.84 |
| TP_THERM_PWR_KTOP | 1 | 6 | 12 | 2989 | 554 | 18.53 | 207 | 6.93 |
| PC_PMU_CONTROL_KMAC | 6 | 8 | 12 | 1762 | 249 | 14.13 | 128 | 7.26 |
| L_TABLEWALK_KMAC | 1 | 12 | 12 | 1081 | 137 | 12.67 | 80 | 7.40 |
| PC_PERFTHROT_KMAC | 6 | 8 | 12 | 1583 | 352 | 22.24 | 131 | 8.28 |
| PC_RAS_KMAC | 6 | 8 | 12 | 1835 | 401 | 21.85 | 156 | 8.50 |
| TP_CLKCTRL_KMAC | 1 | 6 | 12 | 2193 | 434 | 19.79 | 217 | 9.90 |
| PC_FIR_KMAC | 6 | 8 | 12 | 1774 | 367 | 20.69 | 194 | 10.94 |
| TP_PLL_CTRL_KMAC | 1 | 6 | 12 | 1157 | 213 | 18.41 | 128 | 11.06 |
| TP_DBG_KTOP | 1 | 6 | 12 | 2603 | 515 | 19.78 | 322 | 12.37 |
| TP_GLOB_NEST_KMAC | 1 | 6 | 12 | 1905 | 472 | 24.78 | 241 | 12.65 |
| MCGSCEG_KMAC | 1 | 6 | 12 | 1487 | 460 | 30.93 | 384 | 25.82 |

The results range for almost negligible for L15 ARB WRAP to more than a quarter of the latch pairs gated for MCGSCFG KMAC. The wide range of results are due to the inherent difference in the various block and the varying amount of effort that was put into manual clock gating previously to the mechanism of the invention being run.

In alternative embodiments, the methods of the present invention may be applicable to implementations of the invention in integrated circuits, field programmable gate arrays (FPGAs), chip sets or application specific integrated circuits (ASICs), DSP circuits, wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of filtering a plurality of candidate clock gating solutions, each candidate clock gating solution incorporating data logic and clock enable logic, said method comprising the steps of:
for each said clock gating candidate solution, determining an intersection coefficient by determining a number of input signals shared by said data logic and said clock enable logic of said candidate clock gating solution; and
considering only clock gating solutions having a number of shared inputs less than or equal to a predetermined threshold.

2. The method according to claim 1, further comprising the step of generating an advice file comprising results of said step of considering.

3. A method of estimating the quality of a plurality of clock gating solutions, said method comprising the steps of:
determining an intersection coefficient for each candidate clock gating solution;
comparing each said intersection coefficient against a predetermined threshold; and
if said intersection coefficient is less than or equal to said threshold, adding the corresponding candidate clock gating solution to a set of acceptable candidate clock gating solutions.

4. The method according to claim 3, further comprising the step of generating an advice file comprising said set of acceptable candidate clock gating solutions.

5. The method according to claim 3, further comprising the step of adding said corresponding candidate clock gating solution to a set of unacceptable candidate clock gating solutions if said intersection coefficient is greater than said threshold.

6. The method according to claim 3, wherein said step of determining comprises determining the number of inputs shared between data logic and clock enable logic of a candidate clock gating solution.

7. A method of estimating the quality of a plurality of candidate clock gating solutions, said method comprising the steps of:
determining an intersection coefficient value of each candidate clock gating solution; and
eliminating from consideration candidate clock gating solutions having an intersection coefficient value greater than a predetermined threshold.

8. The method according to claim 7, further comprising the step of generating an advice file comprising candidate clock gating solutions remaining after said step of eliminating.

9. The method according to claim 7, wherein said step of determining comprises determining the number of inputs shared between data logic and clock enable logic of a candidate clock gating solution.

10. The method according to claims 1, wherein said predetermined threshold is configured as an input parameter by a user, predetermined or configured dynamically in accordance with one or more metrics measured during processing of candidate solutions.

11. The method according to claims 1, wherein said plurality of candidate clock gating solutions are applied to a logic element chosen from the following group: a flip-flop, a latch, a latch-pair as used in two-phase design, a latch-pair with intervening logic as used in two-phase design.

12. The method according to claims 1, wherein said plurality of candidate clock gating solutions are determined by either a standalone clock gating tool or a clock gating tool embedded in a different hardware design tool.

13. A computer program product, comprising:
a computer usable medium having computer usable program code for estimating the quality of a plurality of candidate clock gating solutions, said computer program product including;
computer usable program code for determining an intersection coefficient value of each candidate clock gating solution; and
computer usable program code for eliminating from consideration candidate clock gating solutions having an intersection coefficient value greater than a predetermined threshold.

14. The computer program product according to claim 13, wherein said predetermined threshold is configured as an input parameter by a user, predetermined or configured dynamically in accordance with one or more metrics measured during processing of the candidate solutions.

15. The computer program product according to claim 13, further comprising the step of generating an advice file comprising candidate clock gating solutions remaining after said step of eliminating.

16. The computer program product according to claim 13, wherein said step of determining comprises determining the number of inputs shared between data logic and clock enable logic portions of a candidate clock gating solution.

17. The method according to claim 13, wherein said plurality of candidate clock gating solutions are applied to a logic element chosen from the following group: a flip-flop, a latch, a latch-pair as used in two-phase design, a latch-pair with intervening logic as used in two-phase design.

18. The method according to claim 13, and wherein said plurality of candidate clock gating solutions are determined by either a standalone clock gating tool or a clock gating tool embedded in a different hardware design tool.
